(19) United States
(12) Patent Application Publication
(10) Pub. No.: US 2019/0005416 A1
(43) Pub. Date: Jan. 3, 2019

(54) PROCESS AND SYSTEM FOR IDENTIFYING USER TRAVEL RESERVATIONS THROUGH FACIAL BIOMETRICS AND A USER TRAVEL RESERVATION CHECK-IN PROCESS

(71) Applicant: GOL LINHAS AÉREAS S.A., Rio de Janeiro (BR)

(72) Inventor: Paulo Palaia Sica, Mogi das Cruzes (BR)

(21) Appl. No.: 16/022,226

(22) Filed: Jun. 28, 2018

(30) Foreign Application Priority Data
Jun. 30, 2017 (BR) BR1020170143384

(51) Int. Cl. G06Q 10/02; G06K 9/00; G06F 17/30

(52) U.S. Cl. CPC G06Q 10/025; G06Q 50/14; G06F 17/30247; G06K 9/00288

(57) ABSTRACT

In order to attain the objectives described above, this invention provides a process for the identification of user travel reservations through facial biometrics, with a user's facial biometrics being registered through an electronic device containing the means for obtaining the facial biometrics of such user and connected to a network. The process comprises the stages of obtaining an image of the user with the facial biometrics thereof, searching through a database to find a travel reservation associated with facial biometrics similar to the facial biometrics registered by the user and presenting a list of trips corresponding to the facial biometrics registered by the user. Additionally, this invention addresses a process for handling check-ins for the travel reservations of a user whereby, should a database contain a travel reservation associated with facial biometrics similar to those of the user, the process automatically completes the user check-in for such reservation. This invention also addresses a user travel reservation identification system working through facial biometrics, adapted to handle the stages of the process described above.

### CROSS-REFERENCE TO RELATED APPLICATION

The present application claims priority to Brazilian Patent Application No. BR1020170143384, filed Jun. 30, 2017. The priority application, BR1020170143384, is hereby incorporated by reference in its entirety.

### TECHNICAL FIELD

This invention refers to a travel management process and system that uses biometric user authentication in order to access information on travel reservations and help a user check-in through a remote device. More specifically, the proposed invention consists of an application for handheld communication devices that can use a means of obtaining an image comprised of a handheld device for capturing an image of the face of a user purchasing a travel ticket, identified through biometric facial recognition, thus helping ensure a fast and simple check-in.

### BACKGROUND OF THE INVENTION

Transportation systems that involve sea, air or rail travel carry large numbers of passengers on a single trip. Large numbers of passengers may make service management complex, whereby carriers require large service facilities such as departure areas staffed by ground crew.

Consequently, when passengers are checking in, carriers must identify their passengers and their respective trips at the departure locations, where passengers are requested to present identification documents such as identity cards, passports, credit cards, boarding passes and others. Due to the large number of passengers on each trip, the check-in stage with the carrier may be lengthy, causing long lines of passengers waiting to be assisted. Large numbers of passengers lining up often results in boarding delays, which is an undesirable situation as means of transportation have scheduled departure times. Furthermore, carriers need more service capacity, meaning more attendants and/or devices for assisting passengers.

It thus became necessary for carriers to develop solutions that would simplify their procedures while also streamlining passenger services.

Along these lines, widespread expansion of the use of devices allowing communication through Internet connections allowed many procedures to be undertaken in a wide variety of fields. Consequently, easy Internet access also proved beneficial for performing travel reservation procedures in simpler and easier ways. Prompted by the broad range of communication devices connected through the Internet, many solutions were developed in order to streamline and facilitate user identification in order to manage travel reservations.

For example, document US 2010228577 describes application that may be run on a mobile device configured for wireless communication, in order to provide improved, real-time travel organization and messaging. Specifically, it describes a system that allows the user to receive travel-related notifications and also sent updated information, such as the user's location. The application is also described in a manner that allows the user to book, maintain or eliminate a travel reservation.

Document US 2010190510 describes a system and method for integrating travel services in a single application available through a portable electronic device whereby a user may access and control travel services before arriving at the travel location, on arrival at the location of travel, or after travel. The passenger may thus reserve a travel itinerary or check-in remotely for a reservation. However, document US 2010190510 does not specify user identification.

Document U.S. Pat. No. 8,215,546 describes a method and system for transportation check-in, such as ticketing and identification through near field communication (NFC) using a handheld electronic device such as a smartphone. The handheld device may store and transmit travel reservations and traveler identifications using a travel management application. The method allows the passenger to use the electronic device in order to check in through NFC with an electronic ticket reader. Furthermore, the passenger may send personal information electronically from a database in order to speed up the security verification process for checking in. This allows the passenger to present personal information on an electronic device to an attendant or electronic reader in order to check in at the departure location, whereby passengers may be identified through using only their handheld devices.

Document U.S. Pat. No. 8,571,902 discloses an apparatus and method for providing self-service passenger check-in facilities at airports or remotely, using a Personal Identification Number (PIN) and at least one biometric identifier through a through fingerprint, iris or retina readings. Once identified, the passenger may thus perform several check-in functions such as altering reservations, printing out boarding passes or confirming check-ins.

As explained above, several solutions to check-in and travel reservation in management problems are available at the state of the art. However, the state of the art still lacks a solution through which users may complete the entire travel check-in process with no need for an identification document. Consequently, the state of the art (as illustrated by the documents listed above) does not offer an advantageous solution for streamlining passenger check-ins in the manner addressed by this invention, as will be described below.

### PURPOSES OF THE INVENTION

The purpose of the invention is to provide a system and/process for identifying travel reservations through biometric data obtained from the mobile communication devices of users whereby their reservations may be identified without using passwords, booking codes or presenting passenger identification documents. To do so, this invention allows users to locate their reservations in order to check in through biometric facial recognition on a handheld device.

Another purpose of this invention is to provide a system and/or process for identifying travel reservations through the biometric data of users, comprised of a database for storing biometric information registered by users through their mobile communication devices, whereby they can be identified when accessing the records of their trips through handheld devices, automated devices in service areas or carrier counters.

### BRIEF DESCRIPTION OF THE INVENTION

In order to fulfil the purposes described above, this invention provides a process for identifying the travel reservations of a user through facial biometrics. The user's facial biometrics are captured through an electronic device connected to a network, such as a smartphone, tablet or an automated totem. The system uses the user's facial biometrics to manage travel reservations and help the user check in through biometric facial recognition. More specifically, the proposed invention is comprised of a process for identifying the travel reservations of a user through facial biometrics that encompasses the stage of obtaining an image of the user through the facial biometrics thereof, with the user's facial biometrics being registered through an electronic device containing the means for obtaining the facial biometrics of such user and connected to a network. The process comprises the stages of obtaining an image of the user through the facial biometrics thereof, searching through a database to find a travel reservation associated with facial biometrics similar to the facial biometrics registered by the user, and presenting a list of trips corresponding to the facial biometrics registered by the user.

This invention also provides a process for handling check-ins for the travel reservations of a user whereby, should a database contain a travel reservation associated with facial biometrics similar to those of the user, the process automatically completes the user check-in for such reservation.

According to the invention, the application uploaded to a handheld device of a user allows such user to check his records, which may be personal data, ticket reservations, etc. The application offers the user the option of providing information on the facial biometrics to be associated with the reservations and used as a user recognition sample for other different transactions. Should the user opt for this procedure, he will be asked to take a picture of his face through a camera built into the electronic device. Once captured, the images then sent to the database through the application and associated with the reservation. When the user wishes to check in, he may opt to search for reservations through facial recognition, sending a picture of his face for verification. Consequently, reservations with registered biometric data corresponding to the new image submitted will be displayed to the user. The user may then select the desired reservation and check in for the trip.

Similarly, this invention refers to a user travel reservation identification system working through facial biometrics. The system comprises an electronic device connected to a network, a means for capturing an image containing the facial biometrics of the user, a means for searching through a database to find a travel reservation associated with facial biometrics similar to the facial biometrics registered by the user, and a display for presenting a list of trips corresponding to the facial biometrics registered by the user.

Also according to this invention, the reservation search stage may be performed by the user through a handheld device or self-service devices such as totems, available at departure locations. Furthermore, this invention allows a user to perform searches in departure locations at customer service counters or stores.

This invention thus provides a process for handheld communication devices that simplifies user identification when checking in for a flight through facial recognition on electronic devices.

### BRIEF DESCRIPTION OF THE FIGURES

FIG. 1 illustrates a first of a series of graphic interface screens provided by the transportation management system to the screen of a mobile communication device such as a smartphone;

FIG. 2 illustrates a second of a series of graphic interface screens provided by the transportation management system to the screen of a mobile communication device such as a smartphone;

FIG. 3 illustrates a third of a series of graphic interface screens provided by the transportation management system to the screen of a mobile communication device such as a smartphone;

FIG. 4 illustrates a fourth of a series of graphic interface screens provided by the transportation management system to the screen of a mobile communication device such as a smartphone;

FIG. 5 illustrates a fifth of a series of graphic interface screens provided by the transportation management system to the screen of a mobile communication device such as a smartphone;

FIG. 6 illustrates a sixth of a series of graphic interface screens provided by the transportation management system to the screen of a mobile communication device such as a smartphone;

FIG. 7 illustrates a seventh of a series of graphic interface screens provided by the transportation management system to the screen of a mobile communication device such as a smartphone;

FIG. 8 illustrates an eighth of a series of graphic interface screens provided by the transportation management system to the screen of a mobile communication device such as a smartphone;

FIG. 9 illustrates a ninth of a series of graphic interface screens provided by the transportation management system to the screen of a mobile communication device such as a smartphone;

FIG. 10 illustrates a tenth of a series of graphic interface screens provided by the transportation management system to the screen of a mobile communication device such as a smartphone;

FIG. 11 illustrates an eleventh of a series of graphic interface screens provided by the transportation management system to the screen of a mobile communication device such as a smartphone; and

FIG. 12 illustrates a twelfth of a series of graphic interface screens provided by the transportation management system to the screen of a mobile communication device such as a smartphone.

### DETAILED DESCRIPTION OF THE INVENTION

The following description is based on a preferred embodiment of the invention, applied to a user-directed transportation management system and process through a handheld communication device, especially for managing flight booked by users. However, as will be evident to any person versed in the art, the invention is not limited to this particular embodiment, far less a specific transportation application, and may be used to manage tickets for travelling by air, road and sea.

This invention describes a process for identifying the travel reservations of a user through facial biometrics, with the user's facial biometrics being registered through an electronic device containing the means for obtaining the facial biometrics of such user and connected to a network. The process comprises the stages of obtaining an image of the user through the facial biometrics thereof, searching through a database to find a travel reservation associated with facial biometrics similar to the facial biometrics registered by the user, and presenting a list of trips corresponding to the facial biometrics registered by the user.

The transportation management process can provide a graphic interface for the user, preferably through an application, whereby such user may browse through the options offered by the system. The transportation management system is connected to a the server of a carrier rendering the respective transportation services. Preferably, this connection is made through a wireless network linking the handheld communication device and the carrier server. This means that assorted information on the transportation options offered by the carrier are provided through the transportation management system.

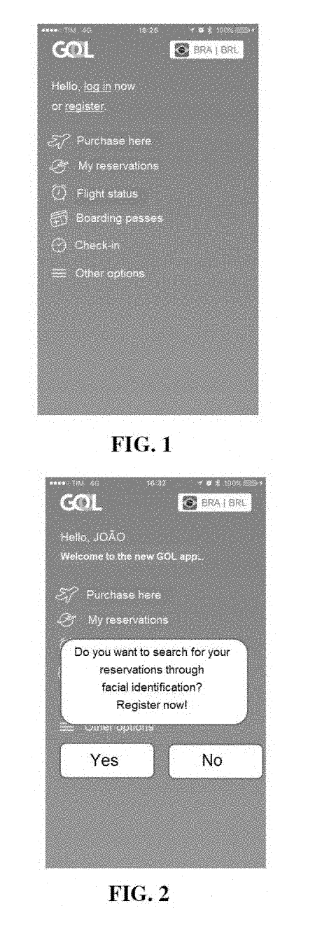

FIG. 1 illustrates an embodiment of the check-in system proposed by this invention. When a user logs into the system, a graphic interface is displayed to the user listing the options offered by the carrier. The graphic interface preferably offers ticket purchase options, information on reservation status and trip status, an on-screen electronic boarding pass, check-in facilities and others. The graphic interface also allows a registered user to login, or a non-registered user to register with the carrier database.

When the user accesses the system through the graphic interface, the system preferably displays and notification to the user, asking whether he wishes to use the facial biometrics registration functions proposed by this invention. FIG. 2 illustrates the situation of a notification overlaid on the graphic interface.

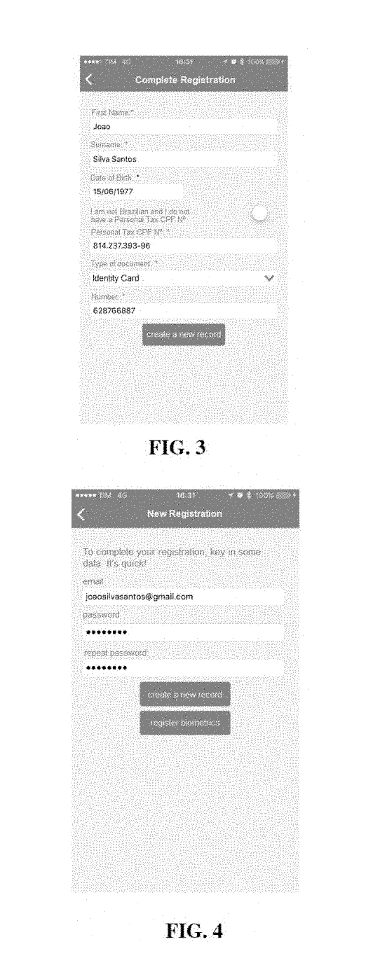

According to a preferred embodiment of this invention, the user must be registered with the carrier database in order to use the system functions. As illustrated in FIG. 3, during the user registration stage, the user must provide the system with some personal information, in order to check in. As shown in FIG. 3, text boxes are displayed to the user completion with personal information, such as first name, surname, date of birth, individual registration number (personal tax CPF number), identification document and others. Optionally, the graphic interface may indicate to the user which information must be keyed in and what information is optional.

According to a preferred embodiment of this invention, after keying in the personal data of the user, a new graphic interface screen will be displayed to the user, requesting user identification information and password. The user identification will preferably consist of his email address. As shown in FIG. 4, the screen will offer the user the option of recording his biometric data for future check-in transactions, which will be described below.

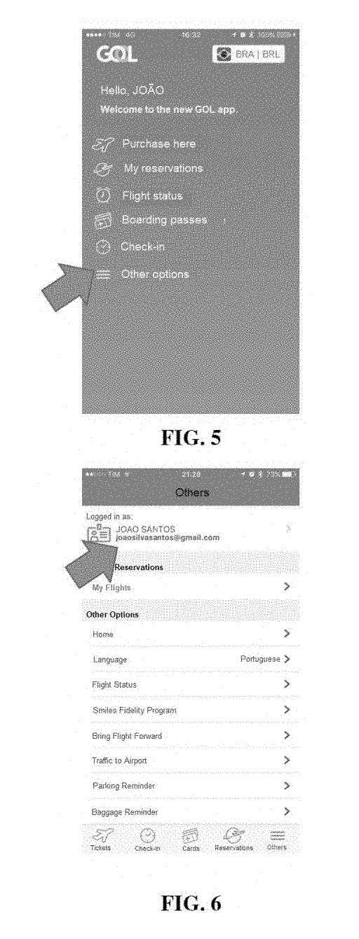

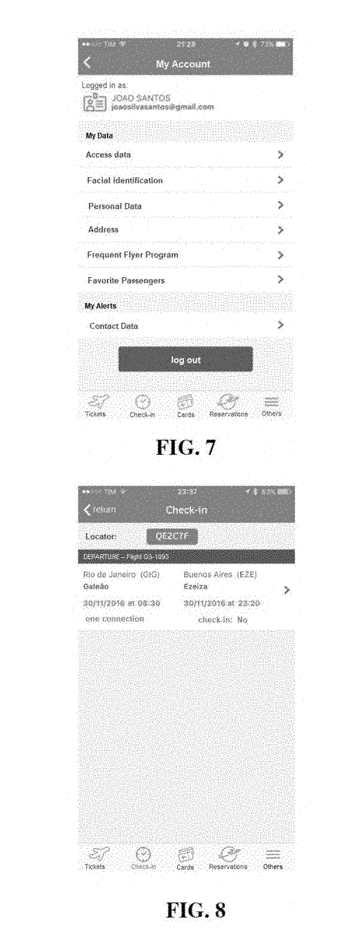

After logging into the system in order to check in, it registered user may manage his registered information, including facial biometric data. FIGS. 5 to 7 illustrate examples of browsing through the graphic interface of the user, where he will manage his facial biometric records. As illustrated in FIG. 7, the user is shown a screen with the facial identification data management whereby, should the user already have facial biometric information registered in the carrier database, he may view the picture and/or remove it. Should the user have no registered facial data, the system will offer the user the possibility of registering his facial biometrics.

Should the user not have registered his biometric identification data, the system will preferably present a screen with instructions on how to take the picture. Examples of such instructions are, but not limited to: staying a certain distance away from the camera fitted to the electronic device; removing dark glasses; and gazing at a specific point, among others. When the picture is taken, the camera fitted to the electronic device is activated whereby the user can take a picture of his face.

According to a preferred embodiment of this invention, the electronic device comprises a mobile communication device such as a smartphone, tablet, notebook, etc. However, the system addressed by this invention may be installed on an electronic device at the place of transportation, such as a totem or customer service desk.

After the capture stage, the system performs the verification stage, during which the user's biometric data are compared to the records stored in the database. During this stage, the system analyses whether its database contains images of other users already registered with biometric information similar to the information of the user. User images may be compared by any image verification method already available at the state of the art, with this not constituting the subject of this invention.

The purpose of the verification stage is to avoid at least two users registering similar facial biometric information. Through this, the system prevents user from being identified as someone else, thus preventing the improper display of the data of this other identified user. This invention thus endows the recognition process with greater security.

Should the system not locate any similar facial biometric data, it successfully registers the biometric information, with the user directed to the biometric identity management homepage, whether user may alter the information in each record, such as removing biometric information already registered, for example. Should the system identify facial biometric data similar to that of the user, it will notify the user that registration is not possible. In this case, the system will request the customer to register again. Preferably, the system start over from the image capture stage, followed by a new verification stage, until registration is completed correctly.

The biometric data registration process will finally be completed for the user, with his facial biometric information duly registered and stored in a database, for use during the facial recognition stages.

FIGS. 8 to 10 describe user check-in stages through the graphic interface with the system, in order to complete the checkout and in process. When a user opts to check in for a reservation, he may browse through the information in each user record, and may insert additional information to be associated with such reservation.

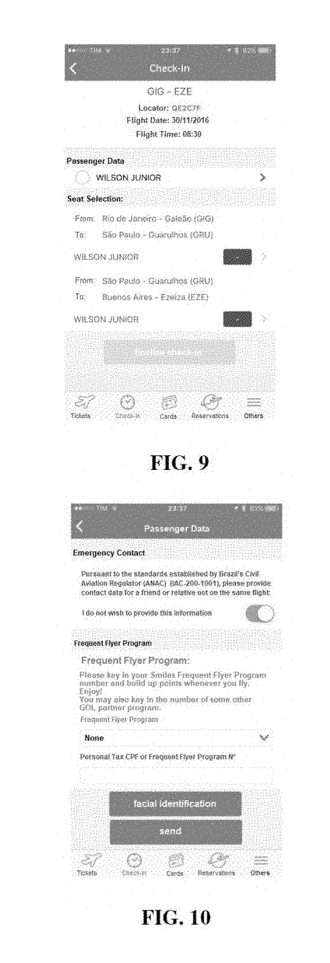

According to FIG. 10, the graphic interface offers the user the option of inserting facial identification for the reservation. Should the user select this option, the system will check whether the user already has facial biometrics associated with such reservation. If the user has no associated facial biometrics, the system will allow the user to register his facial biometrics through the stages described above. Should the user have facial biometrics associated with the reservation, the option of removing such biometrics will be displayed, then associating new biometrics. Preferably, should the user need to register new facial biometrics, he will return to the same stage/graphic interface screen displayed when he decided to register his facial biometrics.

In the embodiment presented in FIG. 10, should the user select a facial biometrics image to be associated with the reservation, the system will check the user in automatically the next time that the user searches for a reservation through facial identification. Preferably, this option may be enabled or disabled through the graphic interface of the system.

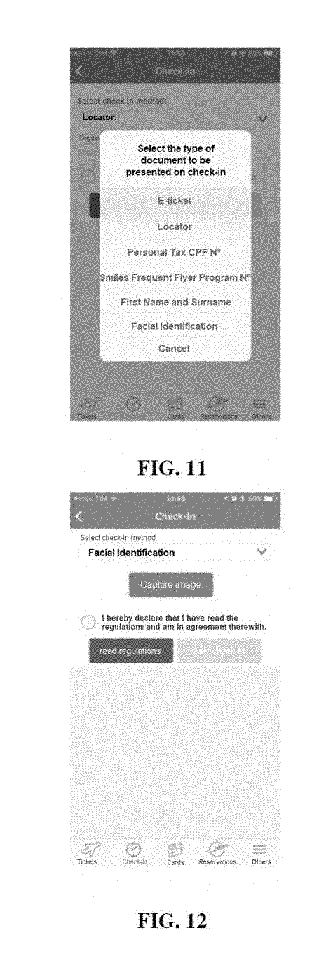

When logging into the application on his handheld device, such as a smart phone, for example, the user may select the reservation search option. When this option is selected, the system will display several reservation search options to the user, such as: a locator code; a personal tax (CPF) number; fidelity program identification; first name and surname, etc. This invention proposes a new way of locating user reservations through the facial biometrics thereof. FIGS. 11 and 12 illustrate the graphic interface of the system addressed by this invention, which lists the reservation search options for the user, including a facial biometrics search.

According to this invention, should the user select the search by facial identification, the system will help him take a photograph of himself on his electronic device. When the user takes this photograph, the system will search the its database for a reservation whose associated facial biometrics correspond to the picture taken by the user. Should the system find a reservation associated with the user image, the management system will display the search results to the user through its graphic interface, displaying reservations made by the user. Should the system not find an associated reservation, the user will be notified that there are no reservations associated with his face. Optionally, should the system not find the reservation, a try-again option will be displayed to the user, who may make another attempt by taking a new photograph.

Optionally, when the system finds a reservation associated with the image of the user, the system will check the user in automatically for the trip on the travel list. This setting is preferred when the system finds only one reservation associated with the image of the user, as there can be no ambiguity about the reservation for which the user is searching. Preferably, this option may be enabled or disabled through the graphic interface of the system.

The user may thus select a reservation and verify such information. When selecting a reservation, the system will provide the user with assorted information and options, such as a check-in option.

According to the optional embodiment in FIG. 12, the graphic interface of the system will request a user to accept the terms of use established by carrier regulations, as already occurs in transportation transactions.

Optionally, the user may also consult his reservations and other transportation information through automated user self-service devices available at locations such as stores departure terminals. The automated device may be a totem, for example, fitted with a camera and connected to a carrier server whereby it may access biometric data registered previously by the user through his handheld device. Consequently, the management transportation system addressed by this invention allows a user who has registered his biometric information through is handheld device to select the facial recognition option on the automated device.

When starting up the information checking operation on the automated device, the interface of the system installed on the device displays the facial recognition identification option. Should the user select this option, the system requests an image capture and activates the camera on the automated device. Once the picture has been taken, the facial biometric data are compared. If the user is not recognized, he will be requested to take another picture for recognition purposes.

Optionally, the system proposed by this invention allows the user to be identified through facial recognition at customer service counters staffed by carrier representatives. To do so, the representative will access a device on the counter, such is a computer, for example, comprising a system connected to a carrier server with access to the facial biometric data registered previously by user through is handheld device. The counter device is comprised of a camera that allows the carrier representative take a picture for the facial recognition of a passenger.

Thus, when the user is assisted at the carrier counter, the carrier representative can identify the user quickly and access the registered information thereof merely through facial recognition. Should the user not be recognized, the carrier representative may take another picture.

If the user is recognized, the system provides the carrier representative with the necessary information of the identified user. The representative can thus check the user in with no need to present identification documents, boarding passes or locator codes.

Optionally, the user travel reservation identification system working through facial biometrics consists of a set of instructions that can be read by a mobile communication device whereby, when performed by the mobile communication device, this ensures that it works with the transportation management system addressed by this invention.

This invention thus presents an advantageous technical solution for managing scheduled travel and checking in through biometric identification data supplied by a mobile communication device of the user. The travel reservation identification system can obtain the facial biometric data of the user and send it to a database for registration and storage. The user may thus search for reservations or check in through the mobile communication device.

The process can also allow the user to search or check in at carrier service terminals. This invention thus offers practicality and security for the user, as none of the means described require user identification through the presentation of a locator code, a fidelity program number, a personal tax (CPF) number, first name and surname, among others.

This invention is also advantageous as the travel reservation identification system can search for reservations and check in through using facial biometric data with no need for specific hardware. The system addressed by this invention is comprised of a set of machine-readable instructions, especially through a mobile communication device fitted with a camera whereby, when performed by the device, it operates like the described system. Consequently, this invention essentially uses the hardware of the mobile communication device of the user, such as a smartphone, which are widely disseminated on the market and whose hardware is increasingly more robust.

This invention is also advantageous as the travel reservation identification system reduces the need for the user to interact with a carrier representative, or interact with a carrier self-service terminal. Using the transportation management system thus reduces the number of carrier representatives needed at the departure location in order to confirm reservations and perform check-ins, consequently lowering back-office costs for the carrier.

Countless variations are permitted within the scope of protection provided by this invention. The travel reservation identification system addressed by this invention is endowed with an application of special interest for air transportation management, as this invention discloses a process that can simplify the check-in process. The process addressed by this invention does not require the use of tickets or boarding passes in order to identify flight reservations. It is thus of particular interest to airlines.

However, the transportation management system addressed by this invention may be used to manage any type of travel ticket, especially when the means of transportation has scheduled trips that are purchased in advance, with a controlled number of users boarded. This consequently underscores the fact that this invention is not limited to the particular configurations/embodiments described above

1. A process for the identification of user travel reservations through facial biometrics, with a user's facial biometrics being registered through an electronic device containing the means for obtaining the facial biometrics of such user and connected to a network, with the process including:
obtaining an image of the user through the facial biometrics thereof;
searching through a database to find a travel reservation associated with facial biometrics similar to the facial biometrics registered by the user; and
presenting the user with a list of trips corresponding to the facial biometrics registered by the user.

2. The process for the identification of user travel reservations according to claim 1, and in presenting the user with a list of corresponding trips, automatically checking the user in for a trip on the list of trips.

3. The process for the identification of user travel reservations according to claim 1, further comprising requesting the user to register his facial biometric data, and upon registration of the user's biometric data, the facial biometrics of the user are associated with a user record in a carrier database.

4. The process for the identification of user travel reservations according to claim 3, and in requesting the user to register his facial biometric data, providing the user with instructions on taking an adequate picture.

5. The process for the identification of user travel reservations according to claim 3, and in requesting user registration:
verifying the presence of records in the database with facial biometric data similar to the facial biometric data of the user;
and, should facial biometric data similar to those of the user be found, advising the user that it is not possible to register the facial biometrics in question; and
should no facial biometric data be found similar to those of the user, advising the user that facial biometrics in question have been registered successfully.

6. The process for the identification of user travel reservations according to claim 5, and requesting the user to submit new facial biometric data, should facial biometric data be found that are similar to those of the user.

7. The process for the identification of user travel reservations according to claim 1, and in obtaining the facial biometrics of the user, the electronic device is comprised of one from among: a smartphone, a tablet, a notebook and an automated totem.

8. The process for the identification of user travel reservations according to claim 1, further including requesting user registration in the database, such user registration including requesting the user for at least one item of personal information from among first name, surname, date of birth, personal registration number and identification number.

9. The process for the identification of user travel reservations according to claim 1, further comprising managing user registration, including offering an option to alter user registration data and the biometric image associated with such user registration.

10. A process for handling check-ins for the travel reservations of a user through facial biometrics, with the user's facial biometrics being registered through an electronic device containing the means for obtaining the facial biometrics of such user and connected to a network, comprising:
obtaining an image of the user through the facial biometrics thereof;
searching through a database to find a travel reservation associated with facial biometrics similar to the facial biometrics registered by the user; and
should a travel reservation be located that is associated with facial biometrics similar to those of the user, completing the user check-in for such reservation.

11. A user travel reservation identification system working through facial biometrics, comprising:
an electronic device connected to a network;
means for capturing an image containing the facial biometrics of the user;
means for searching through a database to find a travel reservation associated with facial biometrics similar to the facial biometrics registered by the user; and
a display for presenting a list of trips corresponding to the facial biometrics registered by the user.

12. The user travel reservation identification system according to claim 11, the electronic device is comprised of one from among: a smart phone, a tablet, a notebook and an automated totem.

13. The user travel reservation identification system according to claim 11, the means for capturing the image is a camera.
